(19) United States
(12) Patent Application Publication
(10) Pub. No.: US 2013/0025275 A1
(43) Pub. Date: Jan. 31, 2013

(54) METHOD AND DEVICE FOR ADJUSTING AN END POSITION OF A TURBINE FOR A CHARGING DEVICE HAVING A VARIABLE TURBINE GEOMETRY

(71) Applicant: Robert Bosch GmbH, Stuttgart (DE)

(72) Inventors: Michael BAEUERLE, Eberdingen (DE); Michael Nau, Dornhan/Aischfeld (DE); Markus Deissler, Neckarsulm (DE)

(73) Assignee: ROBERT BOSCH GMBH, Stuttgart (DE)

(21) Appl. No.: 13/644,274

(22) Filed: Oct. 4, 2012

(30) Foreign Application Priority Data
Jun. 10, 2011 (DE) 10 2011 084 086.9

(51) Int. Cl. F02B 37/24; F01D 17/10

(52) U.S. Cl. 60/605.1; 415/1; 415/148

(57) ABSTRACT

In a method for adjusting an end position of guide vanes in a turbine of a charging device in an engine system, the guide vanes are adjusted with the aid of an actuator, the end position depending on a position at a structurally determined end stop, and corresponding to a position of the guide vanes of the turbine at a predetermined gas flow rate. The actuator is activated for adjusting the guide vanes to the end position using a predetermined position value, which holds the guide vanes in the end position.

### BACKGROUND OF THE INVENTION

1. Field of the Invention

The present invention relates to charging devices, e.g., exhaust gas-driven turbochargers for internal combustion engines, as well as to a method for determining the end positions of an actuator for a turbine of a turbocharger having a variable turbine geometry.

2. Background of the Invention

Internal combustion engines are being provided much more frequently with charging devices and in particular with exhaust gas-driven turbochargers. These so-called exhaust gas turbochargers have a turbine, which is provided in the exhaust gas system, the exhaust gas enthalpy of the exhaust gas stream flowing there being converted into mechanical energy for driving a compressor. The turbine has adjustable guide vanes, whose position determines the efficiency of the exhaust gas enthalpy, which is converted into mechanical energy.

Published European patent application document EP 2 208 863 A1 describes a turbocharger having a variable turbine geometry, the guide vanes being adjustable between a first and a second end position. The adjusting movements of the guide vanes are limited by mechanical stops, which define the positions of the guide vanes for a minimal exhaust gas flow rate in the first end position and for a maximal exhaust gas flow rate in the second end position. The minimal exhaust gas flow rate has in the past been adjusted individually for each turbocharger with the aid of an adjustable mechanical stop.

### BRIEF SUMMARY OF THE INVENTION

According to a first aspect of the present invention, a method for adjusting an end position of guide vanes in a turbine of a charging device in an engine system is provided, the guide vanes being adjustable with the aid of an actuator, the end position depending on a position at a structurally determined end stop, and being determined by a mechanical blockage, this end position corresponding to a position of the guide vanes of the turbine at a predetermined gas flow rate, and, to adjust the guide vanes to the end position, the actuator being activated using a predetermined position value, which holds the guide vanes in the end position.

In exhaust gas-driven turbines for charging devices, an end position of the actuator for guide vanes is usually defined for a minimal exhaust gas flow rate. The adjustment process for the end position for the minimal gas flow rate is necessary since this has effects on the precontrols for an exhaust gas recirculation regulation and/or for air flow regulation and charging pressure regulation, in particular in the transient state.

Instead of adjusting the end position for the minimal gas flow rate mechanically and individually for each turbine with the aid of an adjustment step, it is now provided that the respective end position is defined in the control unit on the basis of a position of the guide vanes at a structurally determined mechanical end stop. In the case of a structurally determined mechanical end stop, the guide vanes are in a defined position at a lower gas flow rate than the minimal gas flow rate required for the end position.

In addition, the method may be carried out largely automatically, and in particular an adjustment procedure which was previously necessary using an adjustable mechanical stop, which must be adjusted individually for each turbine, is now omitted. In addition, due to the regular determination of the end position in a control unit, age-related wear and thus age-related changes in the minimal gas flow rate may also be taken into account, whereas this is impossible when using adjustable mechanical stops.

In addition, the end position may correspond to a position of the guide vanes, which is between two structurally determined end stops.

It may be provided that for adjusting the guide vanes to the end position, the actuator is activated using a predetermined position value, the guide vanes being held by the actuator to prevent deflection in two directions of movement.

According to one specific embodiment, the predetermined position value may be ascertained by the following steps:
moving the guide vanes of the turbine to an end stop;
detecting an end stop position value, which is assigned to the position of the guide vanes at the end stop;
ascertaining an end position-position value, which indicates a deviation of the end stop from the end position;
providing the predetermined position value as a function of the end stop position value and the end position-position value.

The position, which should be used as the end position for the predetermined gas flow rate, may thus be ascertained with the aid of an adjustment procedure, which yields a position value by which the actuators for the guide vanes are moved in the direction of a second end position (end position for a maximum gas flow rate), starting from the position defined by the end stop, to reach the end position for the predetermined gas flow rate.

In addition, the supplying of the predetermined position value may be carried out as a function of an aging position value, the aging position value taking into account a change over time in the end position-position value.

The end position-position value in particular may be ascertained as an average value of multiple position values, each position value being determined as the position value at a position of the guide vanes at which a predetermined gas flow rate is achieved at a predetermined operating point.

According to another aspect, a device for adjusting an end position of guide vanes in a turbine of a charging device in an engine system is provided, the guide vanes being adjustable with the aid of an actuator, the end position corresponding to a position of the guide vanes of the turbine at a predetermined gas flow rate, the device being designed to activate the actuator for adjusting the guide vanes in the end position at a predetermined position value, which holds the guide vanes in the end position.

In addition, the device may be designed
to move the guide vanes of the turbine to an end stop;
to detect an end stop position value which is assigned to the position of the guide vanes at the end stop;
to ascertain an end position-position value, which indicates a deviation of the end stop from the end position;
to provide the predetermined position value as a function of the end stop position value and the end position-position value.

According to another aspect, an engine system is provided, which includes:
an internal combustion engine having a charging device, which includes a turbine having adjustable guide vanes,
the above-mentioned device.

### BRIEF DESCRIPTION OF THE DRAWINGS

FIG. 1 shows a schematic diagram of an engine system having an exhaust gas-driven charging device.

FIG. 2 shows a detail of a cross-sectional diagram through a turbine of an exhaust gas-driven charging device having guide vanes.

FIG. 3 shows a flow chart to illustrate a method for adapting a turbine having a variable turbine geometry.

FIG. 4 shows a detail of a cross-sectional diagram through a turbine of an exhaust gas-driven charging device having guide vanes in a stop position.

FIG. 5 shows a detail of a cross-sectional diagram through a turbine of an exhaust gas-driven charging device having guide vanes in an end position for a minimal gas flow rate.

### DETAILED DESCRIPTION OF THE INVENTION

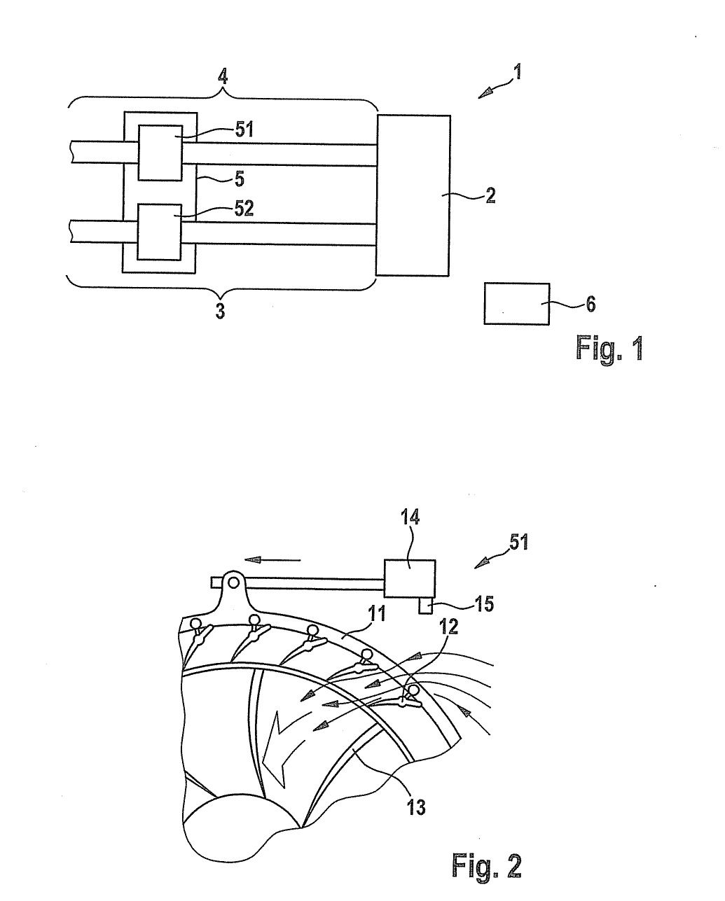

FIG. 1 shows schematically an engine system 1 having an internal combustion engine 2, e.g., a diesel engine or a gasoline engine. Air is supplied to internal combustion engine 2 via an air intake section 3. Combustion exhaust gas expelled from internal combustion engine 2 is discharged via an exhaust gas discharge section 4.

A charging device 5 having a turbine 51 in exhaust gas discharge section 4 is provided. Turbine 51 converts the exhaust gas enthalpy of the combustion exhaust gas conveyed through exhaust gas discharge section 4 into mechanical energy. Turbine 51 is mechanically connected to a compressor 52 in air intake section 3, in such a way that compressor 52 is driven.

Compressor 52 draws in fresh air from the surroundings and supplies it to air intake section 3 under a charging pressure. The mechanical energy supplied to compressor 52 is determined, on the one hand, by the exhaust gas enthalpy, which is made available and depends essentially on the operating point of internal combustion engine 2, and, on the other hand, by the position of the guide vanes in the interior of turbine 51.

The position of the guide vanes essentially determines the efficiency of the charging device, i.e., the proportion of exhaust gas enthalpy which is contained in the combustion exhaust gas and is converted into mechanical energy for driving compressor 52.

In addition, a control unit 6 is provided, which controls the operation of engine system 1 according to an external specification and modeled state variables detected by sensors. Control unit 6 also controls the position of the guide vanes of turbine 51 to determine the efficiency of charging device 5 to carry out a charging pressure regulation or the like.

FIG. 2 schematically shows a detail of a cross-sectional diagram through a turbine 51 for an exhaust gas-driven charging device 5. An adjusting element 11 is apparent, which is pivotable against a turbine housing (not shown). Guide vanes 12 are pivotably mounted on the turbine housing. In addition, guide vanes 12 are connected to adjusting element 11, so that a relative adjustment of adjusting element 11 with respect to the turbine housing results in a pivoting movement of guide vanes 12. The adjustment of adjusting element 11 is induced by an actuator 14, which may be designed as a pneumatic or electric actuator. For controlling a gas flow, guide vanes 12 are situated on turbine blades 13 in the circumferential direction which are situated inside of turbine 51. Actuator 14 is also connected to a position sensor 15 to assign a corresponding position value to each position of guide vanes 12.

During operation of exhaust gas turbocharger 5, it is provided that guide vanes 12 are to be pivoted between two end positions. A first end position corresponds to a position in which a minimal defined gas flow rate through turbine 51 is achieved at a certain operating point of engine system 1. A second end position of guide vanes 12 corresponds to a position in which a defined maximal gas flow rate through turbine 51 is achieved.

Providing the first end position for a minimal gas flow rate is necessary since this has effects on the precontrol of the exhaust gas recirculation and on the air flow and charging pressure regulation in the transient state in particular. This results in a direct correlation with nitrogen oxide and particle emissions.

In addition, the exhaust gas backpressure is influenced. If this increases due to a faulty adjustment of the minimal gas flow rate or a faulty adaptation of age-related parameters, then the charge cycle losses increase.

It is therefore necessary to accurately adjust the first end position for the minimal gas flow rate and to be able to move guide vanes 12 into the first end position. To avoid a mechanical stop for determining the first end position which must be adjusted individually for each engine, it is now provided that a specification for the first end position of guide vanes 12 be stored in control unit 6 and retrieved as needed.

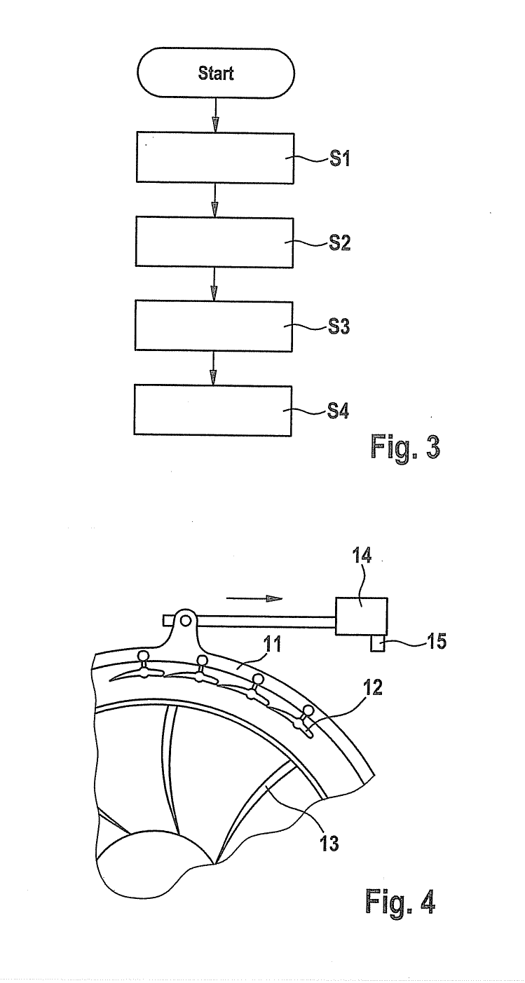

The ascertainment of the specification for the first end position is described on the basis of a method for adapting a turbine 51 having a variable turbine geometry according to the flow chart in FIG. 3. In a step S1, guide vanes 12 of turbine 51 are closed completely during an engine overrun, i.e., they are run up to the structurally determined mechanical end stop at which guide vanes 12 are in contact with one another. Further movement of guide vanes 12 in the direction of the closed position is then blocked since guide vanes 12 are in contact with one another. The first end stop is usually arbitrary and requires a gas flow rate of zero or of a value which is lower than the gas flow rate provided for a first end position.

In one possible exemplary embodiment, FIG. 4 shows the position of guide vanes 12, which is established when they are moved toward the structurally determined end stop. Guide vanes 12 may assume a position in contact or overlapping with an adjacent guide vane 12, thereby producing the greatest possible flow resistance.

The position of guide vanes 12 at the first end stop is detected by position sensor 15 and a corresponding end stop position value X₀ is stored in the control unit (step S2). This end stop position value X₀ will have a slight scattering in the case of unaged charging devices, which results only from component tolerances and manufacturing tolerances. The position of the first end stop may also be ascertained on the basis of the measurement of multiple charging devices 5 by averaging end stop position value X₀ thereby ascertained.

In step S3 the desired position value for the minimal gas flow rate is determined in the form of a value x in the control unit. Value x is obtained by measuring a certain statistically relevant quantity of turbines 51 on a flow bench. The measurement is carried out at a predefined operating point of turbine 51, e.g., at a predetermined turbine rotational speed and a predetermined differential gas pressure, guide vanes 12 being adjusted by continuous measurement of the gas flow rate until a desired gas flow rate is reached.

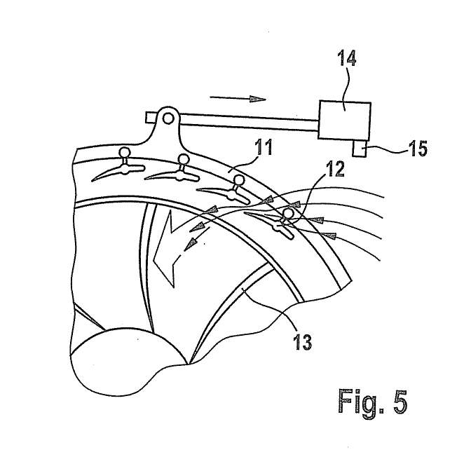

For the approach to the first end position, actuator 14 for guide vanes 12 may now be activated according to the specification X₀+x. FIG. 5 shows turbine 51 in cross section, in which guide vanes 12 are in the first end position.

Instead of the first end stop, a position of the second end stop may also be approached and measured as an alternative. The desired position value for the minimal gas flow rate may then be ascertained, starting from the second end stop.

In addition, a correction value of Δx(t) may be taken into account. Correction value Δx(t) depends on the wear status over the lifetime of charging device 5. A time-dependent correction function Δx(t) may therefore be ascertained on a flow bench on the basis of a statistically relevant quantity of measured differently aged turbochargers.

In step S4, the first end position of guide vanes 12 is approached when required by control unit 6. At the same time, guide vanes 12 are prevented from assuming positions between the learned end position and the first end stop.

The position of end stop X₀ may be learned at regular intervals, e.g., during engine overrun. This should preferably take place at the same temperature of charging device 5. For example, the engine temperature or the oil temperature (ten minutes after stopping internal combustion engine 2, for example) may be used as the starting point.

What is claimed is:

1. A method for adjusting an end position of guide vanes in a turbine of a charging device in an engine system, the method comprising:
adjusting the guide vanes with the aid of an actuator, wherein the end position of the guide vanes depend on a position at a structurally determined end stop and on a position of the guide vanes at a predetermined gas flow rate;
wherein for adjusting the guide vanes to the end position, the actuator is activated using a predetermined position value which holds the guide vanes in the end position.

2. The method as recited in claim 1, wherein the end position corresponds to a position of the guide vanes which is between two structurally determined end stops.

3. The method as recited in claim 2, wherein the actuator is activated using the predetermined position value for adjusting the guide vanes to the end position so that the guide vanes are held by the actuator to prevent the actuator from being deflected in two directions of movement.

4. The method as recited in claim 1, wherein the predetermined position value is ascertained by:
moving the guide vanes of the turbine to the end stop, which is determined by mechanical blockage;
detecting an end stop position value which is assigned to the position of the guide vanes at the end stop;
ascertaining an end position deviation value, which indicates a deviation of the end stop from the end position;
ascertaining the predetermined position value as a function of the end stop position value and the end position deviation value.

5. The method as recited in claim 4, wherein the predetermined position value is supplied as a function of an aging position value which represents a change over time in the end position deviation value.

6. The method as recited in claim 4, wherein the end position deviation value is ascertained as the average value of multiple position values each representing a position value at a position of the guide vanes in which a predefined gas flow rate is achieved at a predefined operating point.

7. A device for adjusting an end position of guide vanes in a turbine of a charging device in an engine system, comprising:
an actuator configured to adjust the guide vanes, wherein the end position of the guide vanes depend on a position at a structurally determined end stop and on a position of the guide vanes at a predetermined gas flow rate, and wherein for adjusting the guide vanes to the end position, the actuator is activated using a predetermined position value which holds the guide vanes in the end position.

8. The device as recited in claim 7, wherein the device is configured to: move the guide vanes of the turbine to an end stop; detect an end stop position value assigned to the position of the guide vanes at the end stop; ascertain an end position deviation value which indicates a deviation of the end stop from the end position; and ascertain the predetermined position value as a function of the end stop position value and the end position deviation value.

9. An engine system, comprising:
an internal combustion engine including a turbine having adjustable guide vanes; and
a device for adjusting an end position of guide vanes in a turbine of a charging device in an engine system, the device including an actuator configured to adjust the guide vanes, wherein the end position of the guide vanes depend on a position at a structurally determined end stop and on a position of the guide vanes at a predetermined gas flow rate, and wherein for adjusting the guide vanes to the end position, the actuator is activated using a predetermined position value which holds the guide vanes in the end position.
